(19) United States
(12) Patent Application Publication
(10) Pub. No.: US 2023/0202132 A1
(43) Pub. Date: Jun. 29, 2023

(54) Eco-Friendly Handle Leather Capable of Removing Moistures

(71) Applicant: Swojin Enterprise Co., Ltd., Taichung City (TW)

(72) Inventor: Chien-Tan Lee, Taichung City (TW)

(21) Appl. No.: 18/070,929

(22) Filed: Nov. 29, 2022

(30) Foreign Application Priority Data
Dec. 29, 2021 (TW) 110149446

(51) Int. Cl. B32B 3/26; B32B 5/02; B32B 7/12; B32B 27/40

(52) U.S. Cl. CPC B32B 3/266; B32B 5/024; B32B 7/12; B32B 27/40; B32B 2037/1223

(57) ABSTRACT

An eco-friendly handle leather contains: a thermoplastic polyurethane (TPU) film and a homogeneous hot-melt adhesion film connected on the TPU film to form a pseudo-adhering sheet, a carrier adhered on the pseudo-adhering sheet and made of hygroscopic weave cloth. The TPU film, the homogeneous hot-melt adhesion film, the carrier and the pseudo-adhering sheet are pressed in a heating and pressurizing manner to polymerize the handle leather. The handle leather is slit into multiple strips, and the multiple strips are cut into the handle leather. Before the pseudo-adhering sheet and the carrier are polymerized, the pseudo-adhering sheet and the carrier are punched to form multiple large-diameter suction holes. The pseudo-adhering sheet is physically polymerized with the carrier via the homogeneous hot-melt adhesion film after being heated and pressurized, and the carrier exposes outside or extends out of the multiple large-diameter suction holes and the multiple small-diameter suction holes.

### FIELD OF THE INVENTION

The present invention related to an eco-friendly handle leather capable of removing moistures which is winded around a handle to absorb waters and have slip resistance, thus obtaining hygroscopicity and environmental friendly.

### BACKGROUND OF THE INVENTION

A conventional elongated handle leather is winded around handle/grip of a sports equipment or a handheld object to obtain anti-slip purpose and to absorb hand's sweat of a user, thus avoiding slippery gripping removal from the handle/grip.

The conventional handle leather is natural leather, such as cowhide, but it causes high fabrication cost and poor water absorption, thus having stinky smell, inflexibility, and crack to the conventional handle leather.

To obtain an improved handle leather having comfort touching sense, the improved handle leather contains a polyurethane (PU) film, a carrier adhered on a bottom of the PU film and made of non-woven cloth/fabric. However, the PU film will crack and harden after a period of using time. Furthermore, the carrier has multiple fabric stacked layers to cause inflexibility and poor moisture removal, thus reducing gripping comfort.

The PU film is made of 100% dimethylformamide (DMF) by melting PU polyester pellets and laminating, when the PU film is soaked with waters, the water will react with DMF so that multiple holes are formed on the PU film, but the DMF will damage hand's skin of the user, and it is not in compliance with environmental requirements.

After coating adhesive and adhering the PU film with the carrier, the multiple holes are formed, but the carrier will have poor water absorption because it is made of non-woven cloth/fabric, and the water cannot be eliminated or absorbed via the multiple holes, thus accumulating the water in the handle/grip to lose dryness and anti-slip function. In addition, the handle/grip is wet and has poor durability and using comfort.

The present invention has arisen to mitigate and/or obviate the afore-described disadvantages.

### SUMMARY OF THE INVENTION

The primary aspect of the present invention is to provide an eco-friendly handle leather which contains a thermoplastic polyurethane (TPU) film and a homogeneous hot-melt adhesion film connected on the TPU film to form a pseudo-adhering sheet; before the pseudo-adhering sheet and the carrier are polymerized, the pseudo-adhering sheet and the carrier are punched to form multiple large-diameter suction holes; and multiple small-diameter suction holes are formed around the multiple large-diameter suction holes, such that the TPU film, the homogeneous hot-melt adhesion film, the carrier and the pseudo-adhering sheet are pressed in a heating and pressurizing manner to polymerize a leather material with a predetermined thickness, the pseudo-adhering sheet is physically polymerized with the carrier via the homogeneous hot-melt adhesion film securely and tightly after being heated and pressurized; and the carrier exposes outside or extends out of the multiple large-diameter suction holes and the multiple small-diameter suction holes, thus producing the eco-friendly handle leather, such that waters expose outside or directly contact with the carrier in a close distance so as to be further absorbed downward, thus drying the handle leather when gripping the handle leather, and the eco-friendly handle leather absorbs the waters effectively.

Secondary aspect of the present invention is to provide an eco-friendly handle leather which is anti-slip by using TPU film and carrier so that the handle leather on the handle rebounds when a handle is released after being grasped to obtain using comfort.

Third aspect of the present invention is to provide an eco-friendly handle leather which contains the TPU film, a homogeneous hot-melt adhesion film connected on a bottom of the TPU film to form a pseudo-adhering sheet to obtaining using durability, wherein the TPU film is configured to physically polymerize the pseudo-adhering sheet with the carrier without using adhesive and dimethylformamide (DMF), thus obtaining a using safety of the eco-friendly handle leather to protect a user's skin.

Another aspect of the present invention is to provide an eco-friendly handle leather which is flexible, wherein the carrier is made of the hygroscopic weave cloth and is polymerized with the pseudo-adhering sheet tightly, wherein when a thickness of the hygroscopic weave cloth of the carrier is increased, water and vibration absorption capabilities of the hygroscopic weave cloth is enhanced to achieve using comfort.

### BRIEF DESCRIPTION OF THE DRAWINGS

FIG. 1 is a perspective view showing the steps of making an eco-friendly handle leather according to a preferred embodiment of the present invention.

FIG. 2 is a perspective view showing the assembly of a part of a semi-finished eco-friendly handle leather according to the preferred embodiment of the present invention.

FIG. 3 is a perspective view showing the assembly of a part of the eco-friendly handle leather according to the preferred embodiment of the present invention.

FIG. 4 is a perspective view showing the step of providing a part of the pseudo-adhering sheet of the eco-friendly handle leather according to the preferred embodiment of the present invention.

FIG. 5 is a perspective view showing the assembly of a part of the pseudo-adhering sheet of the eco-friendly handle leather according to the preferred embodiment of the present invention.

FIG. 6 is a perspective view showing the pseudo-adhering sheet of the eco-friendly handle leather being punched to form to form the multiple large-diameter suction holes and the multiple small-diameter suction holes according to the preferred embodiment of the present invention.

FIG. 7 is a perspective view showing the pseudo-adhering sheet of the eco-friendly handle leather being polymerized with the carrier according to the preferred embodiment of the present invention.

FIG. 8 is a cross sectional view showing the application of the eco-friendly handle leather according to the preferred embodiment of the present invention.

FIG. 9 is a perspective view showing the assembly of an eco-friendly handle leather according to another preferred embodiment of the present invention.

### DETAILED DESCRIPTION OF THE PREFERRED EMBODIMENTS

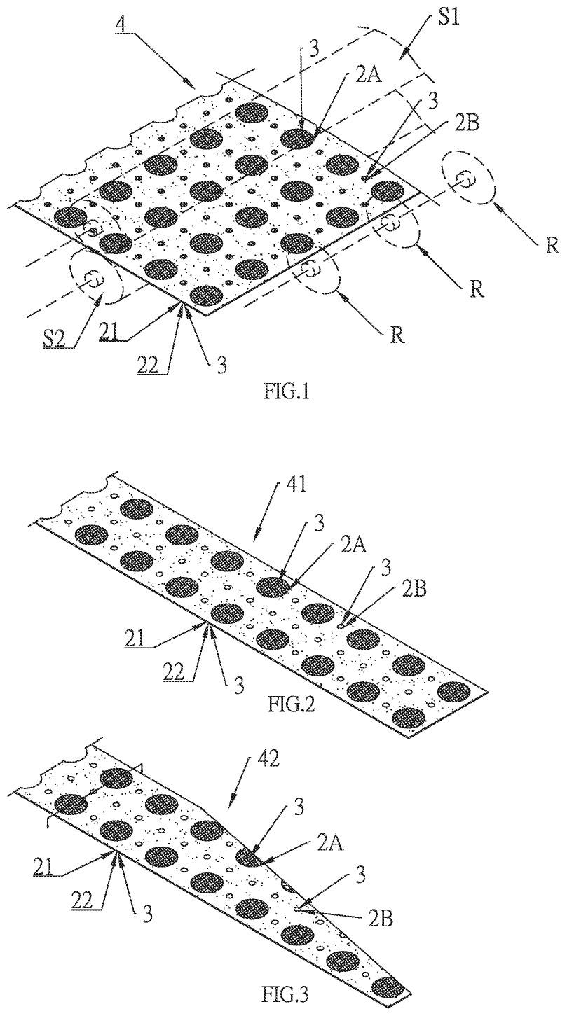

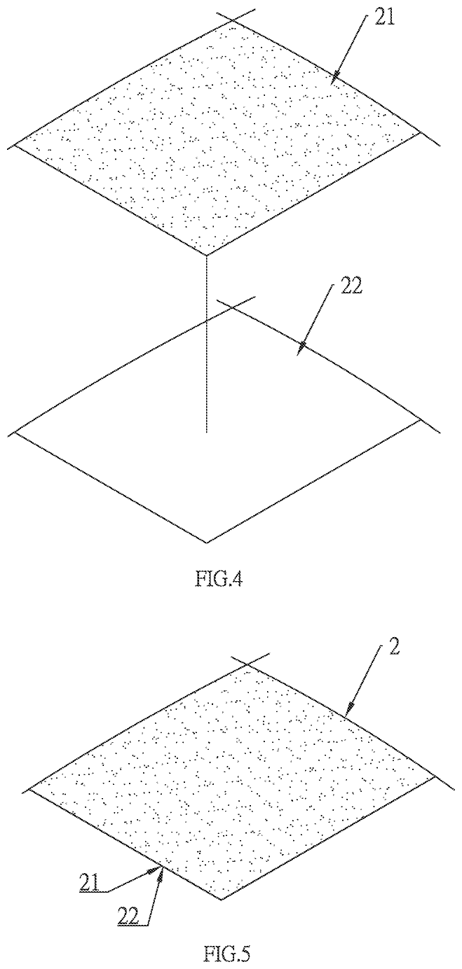

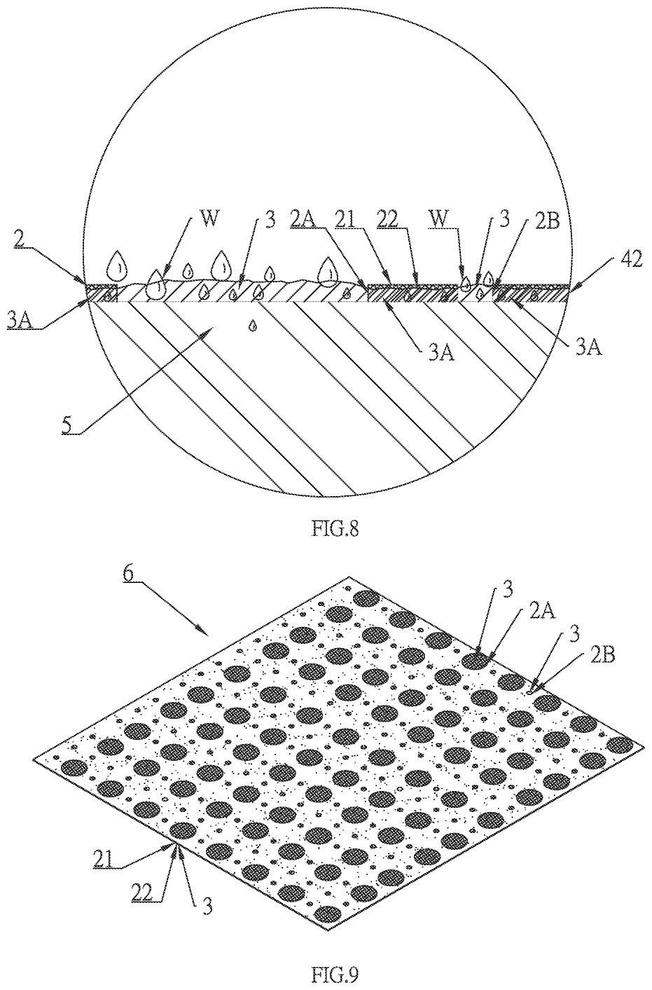

With reference to FIGS. 1-3 and 8, an eco-friendly handle leather capable of removing moistures according to a preferred embodiment of the present invention comprises: a thermoplastic polyurethane (TPU) film 21 and a homogeneous hot-melt adhesion film 22 connected on a bottom of the TPU film 21 to form a pseudo-adhering sheet 2 (as shown in FIGS. 4 and 5), a carrier 3 adhered on a bottom of the pseudo-adhering sheet 2 and made of hygroscopic weave cloth, wherein the TPU film 21, the homogeneous hot-melt adhesion film 22, the carrier 3 and the pseudo-adhering sheet 2 are pressed in a heating and pressurizing manner to polymerize the leather material 4 with a predetermined thickness (as illustrated in FIGS. 1 and 7). The leather material 4 is slit into multiple strips 41 (as shown in FIG. 2) in a predetermined width (, as illustrated in FIG. 1) by using multiple slitting cutters R presented by a dotted line of FIG. 1, and the multiple strips 41 are cut into the eco-friendly handle leather 42 (as shown in FIG. 3).

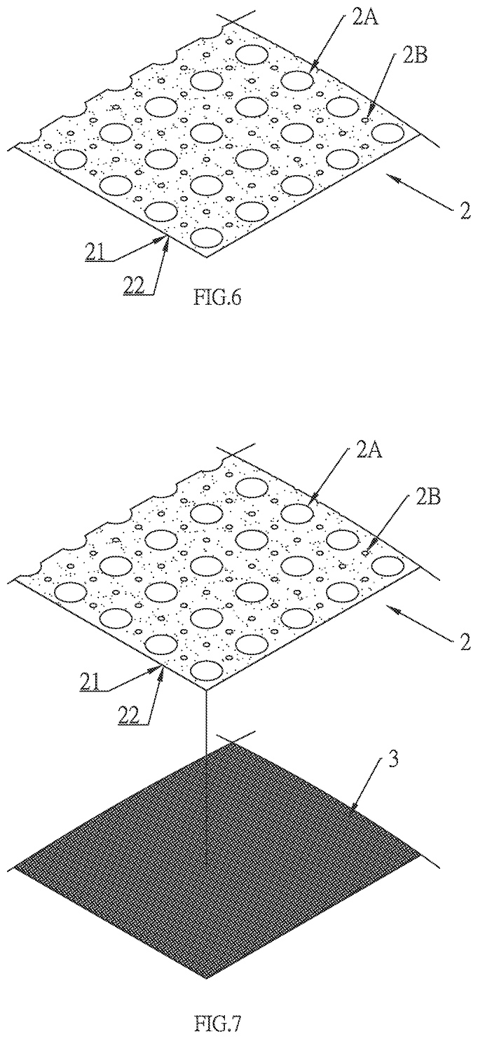

Referring to FIG. 6, before the pseudo-adhering sheet 2 and the carrier 3 are polymerized, the pseudo-adhering sheet 2 and the carrier 3 are punched to form multiple large-diameter suction holes 2A, and multiple small-diameter suction holes 2B are formed around the multiple large-diameter suction holes 2A.

Thereby, the pseudo-adhering sheet 2 is physically polymerized with the carrier 3 via the homogeneous hot-melt adhesion film 22 securely and tightly after being heated and pressurized, and the carrier 3 (i.e., the hygroscopic weave cloth) exposes outside or extends out of the multiple large-diameter suction holes 2A and the multiple small-diameter suction holes 2B, thus producing the eco-friendly handle leather 42 (as shown in FIGS. 1-3).

As illustrated in FIG. 8, a polymerization portion 3A of the carrier 3 and the pseudo-adhering sheet 2 are located beside the multiple large-diameter suction holes 2A and the multiple small-diameter suction holes 2B, the homogeneous hot-melt adhesion film 22 of the pseudo-adhering sheet 2 is heated and is pressurized so that a part of the homogeneous hot-melt adhesion film 22 enters into gaps of the carrier 3 (i.e., the hygroscopic weave cloth), thus connecting the homogeneous hot-melt adhesion film 22 with the carrier 3. Furthermore, the TPU film 21 is configured to physically polymerize the pseudo-adhering sheet 2 with the carrier 3 without using adhesive and dimethylformamide (DMF), thus obtaining a using safety of the eco-friendly handle leather.

With reference to FIG. 8, the carrier 3 (i.e., the hygroscopic weave cloth) exposes outside or extends out of the multiple large-diameter suction holes 2A and the multiple small-diameter suction holes 2B (since the carrier 3 and the pseudo-adhering sheet 2 are not pressed and polymerized, a top of the carrier 3 and the pseudo-adhering sheet 2 is waved) and is a water storage zone, and the polymerization portion 3A of the carrier 3 is an auxiliary water storage zone, wherein in the FIG. 8, different cross-sectional lines are used to distinguish zones.

Referring further to FIG. 8, the handle leather 42 is winded around the handle 5, and waters W expose outside or directly contact with the carrier 3 in a close distance (i.e., the hygroscopic weave cloth) so as to be further absorbed downward, thus drying the handle leather 42. The TPU film 21 is slip resistant, and the flexible carrier 3 is configured to rebound the handle leather 42 after the handle leather 42 is gripped and pressed, thus obtaining a firm grasp, a slip resistance, a high water absorption, and a high flexibility.

Referring further to FIG. 9, a shape and a size of the handle leather 42 is cut based on using requirements to be applicable for a flat cushion 6, such as a yoga mat or a table mat.

While the preferred embodiments of the invention have been set forth for purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. An eco-friendly handle leather capable of removing moistures comprising:
a thermoplastic polyurethane (TPU) film and a homogeneous hot-melt adhesion film connected on a bottom of the TPU film to form a pseudo-adhering sheet, a carrier adhered on a bottom of the pseudo-adhering sheet and made of hygroscopic weave cloth;
the TPU film, the homogeneous hot-melt adhesion film, the carrier and the pseudo-adhering sheet being pressed in a heating and pressurizing manner to polymerize a leather material with a predetermined thickness, the leather material being slit into multiple strips in a predetermined width, and the multiple strips being cut into the eco-friendly handle leather;
wherein before the pseudo-adhering sheet and the carrier are polymerized, the pseudo-adhering sheet and the carrier are punched to form multiple large-diameter suction holes;
wherein the pseudo-adhering sheet is physically polymerized with the carrier via the homogeneous hot-melt adhesion film securely and tightly after being heated and pressurized; and the carrier exposes outside or extends out of the multiple large-diameter suction holes and the multiple small-diameter suction holes, thus producing the eco-friendly handle leather;
wherein waters expose outside or directly contact with the carrier in a close distance so as to be further absorbed downward, thus drying the handle leather when gripping the handle leather, wherein the flexible carrier is configured to rebound the handle leather after the handle leather is gripped and pressed, thus obtaining a firm grasp, a slip resistance, a water absorption, and a high flexibility.
